(19) United States
(12) Patent Application Publication
(10) Pub. No.: US 2026/0339627 A1
(43) Pub. Date: Oct. 29, 2026

(54) DYNAMIC AND EXTENSIBLE REPOSITORY FOR SOFTWARE PROGRAMS

(71) Applicant: NATIONAL INSTRUMENTS CORPORATION, Austin, TX (US)

(72) Inventor: Christopher G. Cifra, Austin, TX (US)

(21) Appl. No.: 19/189,882

(22) Filed: Apr. 25, 2025

(51) Int. Cl. G06F 8/36; G06F 16/22

(52) U.S. Cl. CPC G06F 8/36; G06F 16/2237

(57) ABSTRACT

A computer system that selects a software program is described. During operation, the computer system may receive, from an electronic device, a query. Then, the computer system may generate a search expression based at least in part on the query. Moreover, using the search expression, the computer system may search a repository of software programs for a set of candidate software programs and associated descriptions. Next, the computer system may provide information specifying the set of candidate software programs and the associated descriptions to a pretrained neural network. Furthermore, the computer system may receive, from the pretrained neural network, second information specifying a selected software program in the set of candidate software programs and an associated description. Additionally, the computer system may provide, to the electronic device, third information specifying the selected software program and the associated description.

### FIELD

The described embodiments relate, generally, to a repository of software programs that can be used with a pretrained neural network (such as a large language model or LLM) without predefined training on a particular software program or with a predefined input/output (I/O) format.

### BACKGROUND

The increasing capabilities of electronic devices (such as cellular telephones) have resulted in their wide-spread use in a variety of applications. However, these capabilities and diverse applications have made it difficult to test electronic devices.

Notably, it is often challenging for engineers, who do not have significant software expertise, to identify and use the correct software programs (which are sometimes referred to as ‘test scripts’) from a large number of options. For example, in order to select an appropriate software program, an engineer testing an electronic device typically needs to make sure that a software program (such as a pretrained neural network) has been trained on a software program so that it can be correctly identified. Otherwise, the testing may be incomplete or invalid. Moreover, once a software program is identified, performing the testing and analyzing the results usually involves the use of a different programming language. Consequently, testing of electronic devices is often time-consuming and expensive, and typically requires significant and specialized domain expertise.

### SUMMARY

A computer system that selects a software program is described. This computer may include: an interface circuit that communicates with an electronic device; a computation device (such as a processor, a graphics processing unit or GPU, etc.) that executes program instructions; and memory that stores the program instructions. During operation, the computer system receives, from the electronic device, a query. Then, the computer system generates a search expression based at least in part on the query. Moreover, using the search expression, the computer system searches a repository of software programs for a set of candidate software programs and associated descriptions. Next, the computer system provides information specifying the set of candidate software programs and the associated descriptions to a pretrained neural network (which is sometimes referred to as an ‘artificial neural network’). Furthermore, the computer system receives, from the pretrained neural network, second information specifying a selected software program in the set of candidate software programs and an associated description. Additionally, the computer system provides, to the electronic device, third information specifying the selected software program and the associated description.

Note that the set of candidate software programs may be identified during the searching based at least in part on rank scores. For example, a given rank score in the rank scores may be a weight summation of matches between keywords in the search expression and a given software program in the repository of software programs. Alternatively, the set of candidate software programs may be identified during the searching based at least in part on distances between the query and the descriptions of software programs in the repository of software programs.

Moreover, the repository of software programs may include a vector database. Consequently, the search may include a vector search.

Furthermore, the pretrained neural network may include an LLM.

Additionally, a given description in the descriptions of the given software program may include: a data I/O format, and a configuration. For the given software program, the description may be used to execute the software program. Note that at least some of the software programs in the repository of software programs may have different data I/O formats and/or configurations. Thus, the computer system may use a reflection-based approach to select the software program.

Note that the query may include natural language.

In some embodiments, when a second software program (such as a new or modified software program) is added to the repository of software programs, the computer system may generate an associated description of the second software program based at least in part on source code and one or more related files (such as a readme file) for the second software program. Then, the computer system may store the generated associated description in the repository of software programs.

Moreover, the computer system may receive a context about what a user is doing or attempting to do, and the computer system may generate the search expression based at least in part on the context.

Another embodiment provides a computer-readable storage medium for use with the electronic device or the computer system. When executed by the electronic device or the computer system, this computer-readable storage medium causes the electronic device or the computer system to perform at least some of the aforementioned operations or counterparts to at least some of the aforementioned operations.

Another embodiment provides a method, which may be performed by the electronic device or the computer system. This method includes at least some of the aforementioned operations or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### DRAWINGS

FIG. 1 is a block diagram illustrating an example of a computer system in accordance with an embodiment of the present disclosure.

FIG. 2 is a flow diagram illustrating an example of a method for selecting a software program using a computer system in FIG. 1 in accordance with an embodiment of the present disclosure.

FIG. 3 is a drawing illustrating an example of communication between components in a computer system in FIG. 1 in accordance with an embodiment of the present disclosure.

FIG. 4 is a drawing illustrating a user interface in which a user asks an artificial intelligence (AI) agent what software programs have been called recently in accordance with an embodiment of the present disclosure.

FIG. 5 is a drawing illustrating a user interface in which a user tells the AI agent what datasets are of interest in accordance with an embodiment of the present disclosure.

FIG. 6 is a drawing illustrating a user interface in which a user tells the AI agent to look for anomalies in accordance with an embodiment of the present disclosure.

FIG. 7 is a drawing illustrating a user interface in which the AI agent successfully runs an anomaly detection software program and displays results in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that selects a software program is described. During operation, the computer system may receive, from an electronic device, a query. Then, the computer system may generate a search expression based at least in part on the query. Moreover, using the search expression, the computer system may search a repository of software programs for a set of candidate software programs and associated descriptions. Next, the computer system may provide information specifying the set of candidate software programs and the associated descriptions to a pretrained neural network. Furthermore, the computer system may receive, from the pretrained neural network, second information specifying a selected software program in the set of candidate software programs and an associated description. Additionally, the computer system may provide, to the electronic device, third information specifying the selected software program and the associated description.

By selecting the software program, the disclosed repository techniques may significantly reduce the time and cost of identifying and executing the selected software program. These capabilities may democratize the testing of electronic devices. For example, the repository techniques may allow engineers who are not, per se, software experts to perform the testing. Thus, the repository techniques may allow the testing to be performed without requiring significant and specialized domain expertise. Moreover, the repository techniques may improve the accuracy of the test results. This may ensure that the entire set of software programs available to a user are evaluated and the software program with the best capability and trustworthiness is selected, e.g., using a pretrained neural network having specialized knowledge of the software programs available for selection. Therefore, the repository techniques may improve the user experience when testing electronic devices.

In the discussion that follows, the repository techniques are used to analyze a wide variety of types of data or inputs, including or corresponding to: images (such as ultrasound images corresponding to wavelengths between 0.2 and 1.9 mm, Infra-red images corresponding to one or more wavelengths between 700 nm and 1 mm, optical images corresponding to one or more visible wavelengths between 300 and 800 nm, ultraviolet images corresponding to ultraviolet wavelengths between 10 and 400 nm, or X-ray images corresponding to one or more wavelengths between 0.01 and 10 nm), software code, medical data (such as data associated with an electronic medical record), financial data, economic data, testing data, data associated with a database or data structure, and/or natural language (such as a portion of a narrative, or a portion of a conversation, e.g., between an individual and a pretrained neural network).

In some embodiments, the repository techniques may use one or more neural networks or analysis models that are pretrained or predetermined using a machine-learning technique (such as a supervised learning technique, an unsupervised learning technique and/or a neural network) and a training dataset. For example, the analysis model may include a classifier or a regression model that was trained using: a support vector machine technique, a classification and regression tree (CART) technique, logistic regression, LASSO, linear regression, nonlinear regression, a K nearest-neighbors technique (where K is a non-zero integer), a generative model, a Fisher discriminator, a kernel method, a decision tree, a random forest, a boosting technique, a linear perceptron, a neural network technique (such as a convolutional neural network or CNN, an LLM, an autoencoder neural network, a feedforward neural network, a generative adversarial neural network, a multilayer perceptron neural network, a long short-term memory neural network, a radial basis function neural network, or another type of neural network) and/or another linear or nonlinear supervised-learning technique.

We now describe embodiments of the repository techniques. Notably, in the discussion that follows, the repository techniques are used to select a software program.

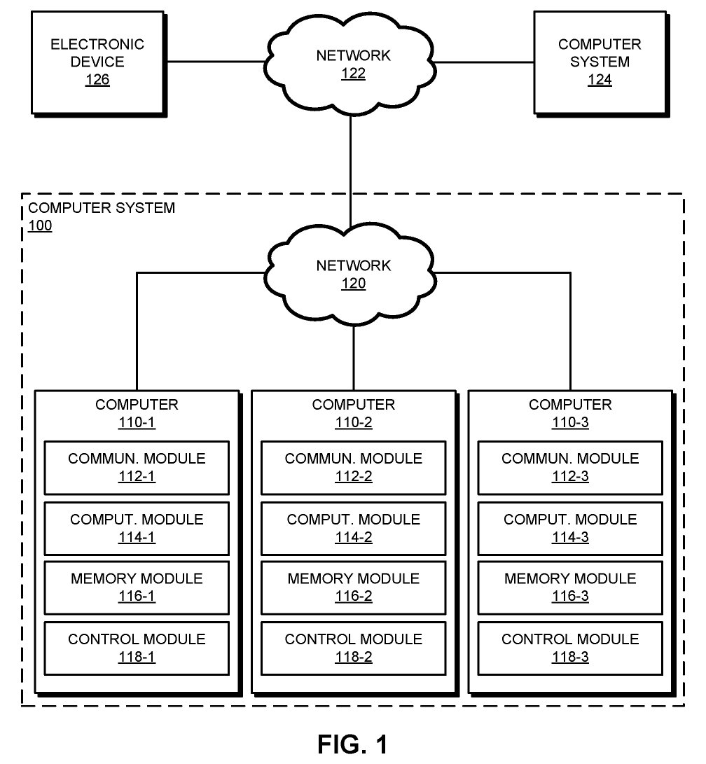

FIG. 1 presents a block diagram illustrating an example of a computer system 100. This computer system may include one or more computers 110. These computers may include: communication modules 112, computation modules 114, memory modules 116, and optional control modules 118. Note that a given module or engine may be implemented in hardware and/or in software.

Communication modules 112 may communicate frames or packets with data or information (such as input vectors or control instructions) between computers 110 via a network 120 (such as the Internet and/or an intranet). For example, this communication may use a wired communication protocol, such as an Institute of Electrical and Electronics Engineers (IEEE) 802.3 standard (which is sometimes referred to as ‘Ethernet’) and/or another type of wired interface. Alternatively or additionally, communication modules 112 may communicate the data or the information using a wireless communication protocol, such as: an IEEE 802.11 standard (which is sometimes referred to as ‘Wi-Fi’, from the Wi-Fi Alliance of Austin, Texas), Bluetooth (from the Bluetooth Special Interest Group of Kirkland, Washington), a third generation or 3G communication protocol, a fourth generation or 4G communication protocol, e.g., Long Term Evolution or LTE (from the 3rd Generation Partnership Project of Sophia Antipolis, Valbonne, France), LTE Advanced (LTE-A), a fifth generation or 5G communication protocol, other present or future developed advanced cellular communication protocol, Citizens Broadband Radio Service (CBRS), and/or another type of wireless interface or wireless communication protocol. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies.

In the described embodiments, processing a packet or a frame in a given one of computers 110 (such as computer 110-1) may include: receiving the signals with a packet or the frame; decoding/extracting the packet or the frame from the received signals to acquire the packet or the frame; and processing the packet or the frame to determine information contained in the payload of the packet or the frame. Note that the communication in FIG. 1 may be characterized by a variety of performance metrics, such as: a data rate for successful communication (which is sometimes referred to as ‘throughput’), an error rate (such as a retry or resend rate), a mean squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). Note that wireless communication between components in FIG. 1 may use one or more bands of frequencies, such as: 900 MHz, 2.4 GHz, 5 GHz, 6 GHz, 7 GHz, 8 GHz, 60 GHz, the CBRS (e.g., a frequency band near 3.5 GHz), and/or a band of frequencies used by LTE or another cellular-telephone communication protocol or a data communication protocol. In some embodiments, the communication between the components may use multi-user transmission (such as orthogonal frequency division multiple access or OFDMA) or multiple-input multiple-output (MIMO).

Moreover, computation modules 114 may perform calculations using: one or more microprocessors, ASICs, microcontrollers, programmable-logic devices, GPUs and/or one or more digital signal processors (DSPs). Note that a given computation component is sometimes referred to as a ‘computation device’.

Furthermore, memory modules 116 may access stored data or information in memory that local in computer system 100 and/or that is remotely located from computer system 100. Notably, in some embodiments, one or more of memory modules 116 may access stored information (such a description associated with a software program or a set of program instructions) in a data structure or a database (e.g., a vector database). Alternatively or additionally, in other embodiments, one or more memory modules 116 may access, via one or more of communication modules 112, stored information in the remote memory in computer system 124, e.g., via network 120 and network 122. Note that network 122 may include: the Internet and/or an intranet. However, in other embodiments, the context may be determined in real-time or on-the-fly and, thus, may not be predetermined and stored in memory.

While FIG. 1 illustrates computer system 100 at a particular location, in other embodiments at least a portion of computer system 100 is implemented at more than one location. Thus, in some embodiments, computer system 100 is implemented in a centralized manner, while in other embodiments at least a portion of computer system 100 is implemented in a distributed manner. This remote processing may reduce the amount of data that is communicated via network 120 and network 122.

Although we describe the computation environment shown in FIG. 1 as an example, in alternative embodiments, different numbers or types of components may be present in computer system 100. For example, some embodiments may include more or fewer components, a different component, and/or components may be combined into a single component, and/or a single component may be divided into two or more components.

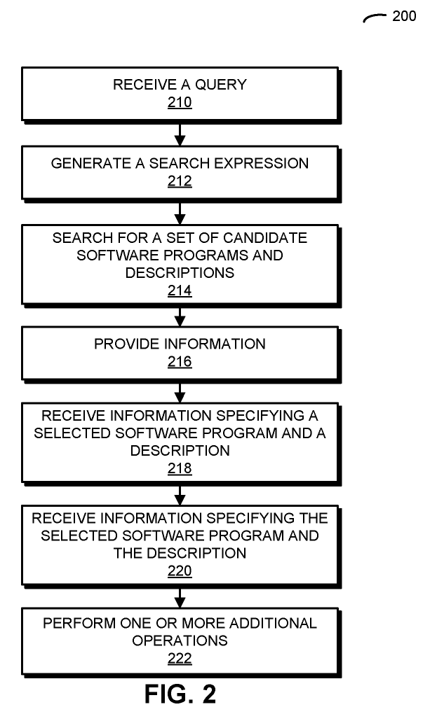

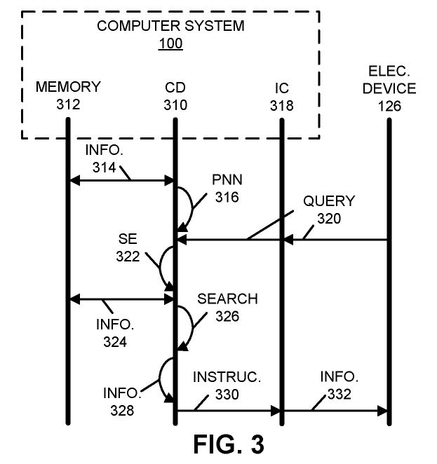

As discussed previously, it can be difficult to test electronic devices. Moreover, as described further below with reference to FIGS. 2 and 3, in order to address these challenges computer system 100 may perform the repository techniques. Notably, during the repository techniques, one or more of optional control modules 118 may divide a search for a software program among computers 110. Then, a given computer (such as computer 110-1) may perform at least a designated portion of the search or analysis.

During operation, communication module 112-1 receive, from electronic device 126 (which may be used by or associated with an engineer and, more generally, a user), a query (such as an input vector). Note that the query may include natural language. In some embodiments, communication module 112-1 may receive a context about what a user is doing or attempting to do, such as a test the user is or is trying to perform.

Then, computation module 114-1 may generate a search expression based at least in part on the query. For example, the search expression may remove high-frequency words (such as ‘a’ or ‘the’) from the query, and may add or include synonyms for keywords in the query. In some embodiments, the search expression is based at least in part on the context.

Moreover, computation module 114-1 may access, in a vector database in or associated with memory module 116-1, information specifying software programs and associated descriptions. For example, a given description for a given software program may include: an I/O format of the given software program, and/or a configuration used when executing the given software program. In some embodiments, at least some of the software programs in the vector database may have different data I/O formats and/or configurations. Then, using the search expression, computation module 114-1 may search the vector database for a set of candidate software programs and associated descriptions.

Note that the set of candidate software programs may be identified during the searching based at least in part on rank scores. For example, a given rank score in the rank scores may be a weight summation of matches between keywords in the search expression and a given software program in the vector database. Alternatively, the set of candidate software programs may be identified during the searching based at least in part on distances between the query and the descriptions of software programs in the vector database.

Next, computation module 114-1 may provide information specifying the set of candidate software programs and the associated descriptions to a pretrained neural network (such as an LLM) is executed by one or more of computation modules 114. Alternatively, in some embodiments, the information may be provided, e.g., using communication module 112-1, to a separate computer system (not shown) that implements and executes the pretrained neural network.

Furthermore, computation module 114-1 may receive, from the pretrained neural network, information specifying a selected software program in the set of candidate software programs and an associated description.

Additionally, computation module 114-1 may instruct communication module 112-1 to provide, to electronic device 126, one or more packets or frames with information specifying the selected software program and the associated description.

In some embodiments, when a new or modified software program is added to the vector database, computation module 114-1 may generate an associated description of the second software program based at least in part on source code and one or more related files (such as a readme file) for the second software program. Then, computation module 114-1 may store the generated associated description in the vector database, e.g., in or associated with memory module 116-1.

In these ways, computer system 100 may significantly reduce the time and cost of identifying and executing the selected software program. For example, by identifying the software program and the associated description, computer system 100 may reduce the amount of memory, processing capability and communication resources needed during the testing of the electronic device. Consequently, the repository techniques may significantly reduce the power consumption and analysis time used during the testing. Consequently, the repository techniques may allow the testing to be performed without requiring significant and specialized domain expertise. Moreover, the repository techniques may improve the accuracy of the test results without requiring that the pretrained neural network (such as an LLM) be trained on a particular dataset or that the software program have a predefined I/O format. Therefore, the repository techniques may improve the user experience when testing electronic devices.

While the previous discussion illustrated the repository techniques with software programs, more generally the repository techniques may be used with an arbitrary type of program or program instructions.

We now describe embodiments of the method. FIG. 2 presents a flow diagram illustrating an example of a method 200 for selecting a software program, which may be performed by a computer system (such as computer system 100 in FIG. 1). During operation, the computer system may receive, from an electronic device, a query (operation 210). For example, the query may include natural language. Then, the computer system may optionally generate a search expression (operation 212) based at least in part on the query.

Moreover, using the search expression, the computer system may search a repository of software programs for a set of candidate software programs and associated descriptions (operation 214). Note that the set of candidate software programs may be identified during the searching based at least in part on rank scores. For example, a given rank score in the rank scores may be a weight summation of matches between keywords in the search expression and a given software program in the repository of software programs. Alternatively, the set of candidate software programs may be identified during the searching based at least in part on distances between the query and the descriptions of software programs in the repository of software programs. In some embodiments, the repository of software programs may include a vector database.

In some embodiments, a given description in the descriptions of the given software program may include: a data I/O format, and a configuration. For the given software program, the description may be used to execute the software program. Note that at least some of the software programs in the repository of software programs may have different data I/O formats and/or configurations.

Next, the computer system may provide information (operation 216) specifying the set of candidate software programs and the associated descriptions to a pretrained neural network (such as an LLM). Furthermore, the computer system may receive, from the pretrained neural network, second information specifying a selected software program (operation 218) in the set of candidate software programs and an associated description (operation 218). Additionally, the computer system may provide, to the electronic device, third information specifying the selected software program and the associated description (operation 220).

In some embodiments, the computer system may optionally perform one or more additional operations (operation 222). For example, when a second software program (such as a new or modified software program) is added to the repository of software programs, the computer system may generate an associated description of the second software program based at least in part on source code and one or more related files (such as a readme file) for the second software program. Then, the computer system may store the generated associated description in the repository of software programs.

Moreover, the computer system may receive, from the electronic device, a context about what a user is doing or attempting to do, and the computer system may generate the search expression based at least in part on the context.

In some embodiments of method 200, there may be additional or fewer operations. Furthermore, the order of the operations may be changed, and/or two or more operations may be combined into a single operation.

Embodiments of the repository techniques are further illustrated in FIG. 3, which presents a drawing illustrating an example of communication among components in computer system 100. In FIG. 3, a computation device (CD) 310 (such as a processor or a GPU) in computer system 100 may access, in memory 312 in computer system 100, information 314 specifying configuration instructions and hyperparameters for a pretrained neural network (PNN) 316. After receiving the configuration instructions and the hyperparameters, computation device 310 may implement the pretrained neural network 316.

Moreover, an interface circuit (IC) 318 in computer system 100 may receive, from electronic device 126, a query 320, which may be provided to computation device 310. Then, computation device 310 may generate a search expression (SE) 322 based at least in part on query 320.

Next, computation device 310 may access, in a repository of software programs in memory 312, information 324 specifying software programs and associated descriptions. Then, computation device 310 may search 326 the repository of software programs for a set of candidate software programs and associated descriptions. Moreover, computation device 310 may provide information specifying the set of candidate software programs and the associated descriptions to the pretrained neural network 316. Furthermore, computation device 310 may receive, from the pretrained neural network 316, information 328 specifying a selected software program in the set of candidate software programs and an associated description.

Additionally, computation device 310 may instruct 330 interface circuit 318 to provide, addressed to electronic device 126, information 332 specifying the selected software program and the associated description.

Note that information 336 may be used to execute the selected software program. For example, an engineer or user of electronic device 126 may use information 336 to call the selected software program.

While FIG. 3 illustrates communication between components using unidirectional or bidirectional communication with lines having single arrows or double arrows, in general the communication in a given operation in this figure may involve unidirectional or bidirectional communication. Moreover, while FIG. 3 illustrates operations being performed sequentially or at different times, in other embodiments at least some of these operations may, at least in part, be performed concurrently or in parallel.

We now further describe embodiments of the repository techniques. The disclosed repository techniques. The repository of software programs may provide a standardized format for software programs and/or a management system that allows users to contribute their own software programs and that enables LLM-based assistants to discover, configure and call a given software program without requiring specialized training, e.g., on the software program.

For example, in some embodiments of the repository techniques, an artificial intelligence (AI)-searchable plugin library may provide a ranked list of software programs (or testing techniques) that match a natural language query or search expression.

One challenge with AI assistants or copilots is making sure that the data is correct, e.g., ensuring that there are good tolerances and no missing corner cases. Moreover, a different programming language is often used when performing tests and to show results of the tests. These operations can be time-consuming and difficult for an engineer other than a software engineer.

In principle, an AI assistant or copilot may be used to write code (such as a software program). However, many AI assistants or copilots use proprietary approaches and a public LLM may not know how to use or interact with them.

In the repository techniques, these problems may be addressed by wrapping software programs in a more-consistent wrapper that is easier for an LLM to understand. For example, the wrapper or description of a given software program may include: data I/O, and a configuration. This reflection-based approach (in which a program language can interrogate software or program instructions that is not standardized) may help constrain any variation, which may allow the LLM to understand it. Consequently, given a software program or function, the LLM may be able to ask how to run it.

In principle, tool calls may be written around the LLM. However, practically, this is often expensive and time consuming. Therefore, in the repository techniques, a catalog or library (such as a vector database) may be created to store the software programs and associated descriptions. Then, a natural language query from a user and/or a context of what the user trying to do or is doing may be used to identify a software program (such as scripted information about the software program).

In some embodiments, information (such as the associated description) may be automatically populated in the repository of software programs based at least in part on the software program or code and/or one or more files associated with the software program (such as a readme file). This information may be standardized in the repository of software programs so that an AI assistant can understand it. A program module or a set of instructions may: search the repository of software programs; identify a software program; provide information specifying the software program; and/or call the software program based at least in part on the information.

When a new or modified software program is added to the repository of software programs, an editor may analyze source code and/or one or more associated files (such as a readme file, a configuration script, one or more libraries it makes use of, etc.) to generate a description of the new or modified software program. Then, this description may be added to the repository of software programs.

During the searching, a given document or file (such as a software program, a description, one or more libraries, etc.) may be chunked into segments (such as sentences) that are added to a vector store. Then, a vector match may be computed with a query and a rank score may be determined. For example, the vector match may be computed using ChromaDB (from Chroma of San Francisco, California).

For example, a query may include “Can you compute a DC offset of a signal.” In response, a test script may be identified in a repository. Then, the test script may be called and executed. The results of executing the test script on an electronic device (e.g., a cellular telephone) may be reported.

Note that the repository may be trusted and proprietary or internal to a company or an organization. This may ensure that the software programs are vetted, thereby preventing a security risk (such as the possible inclusion of malware or a virus in a software programs).

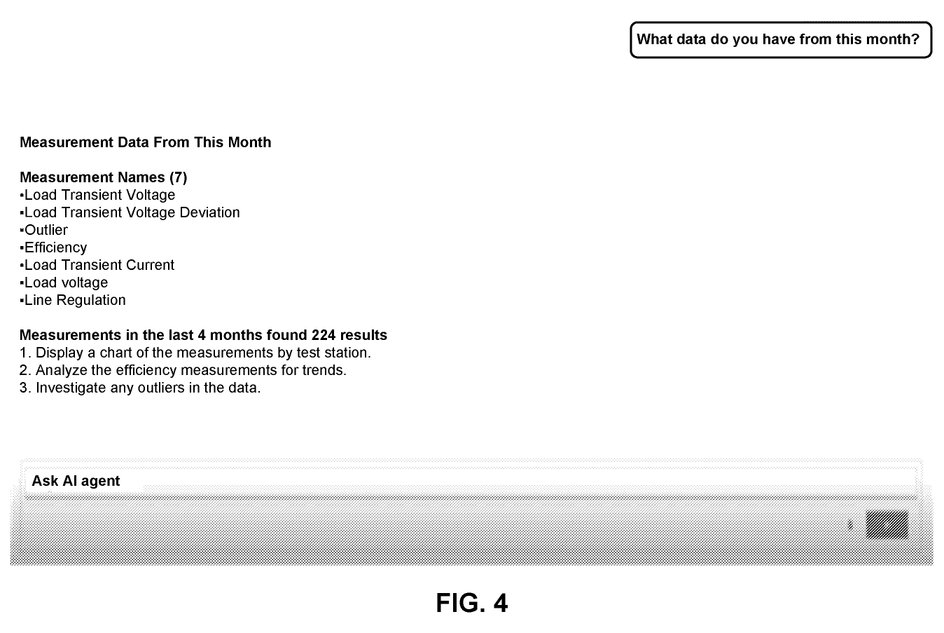

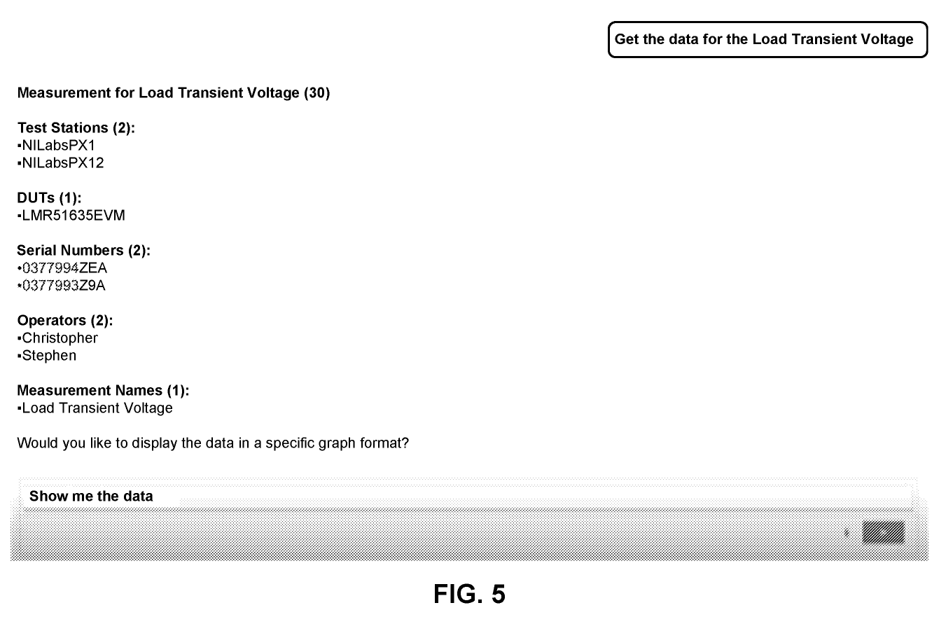

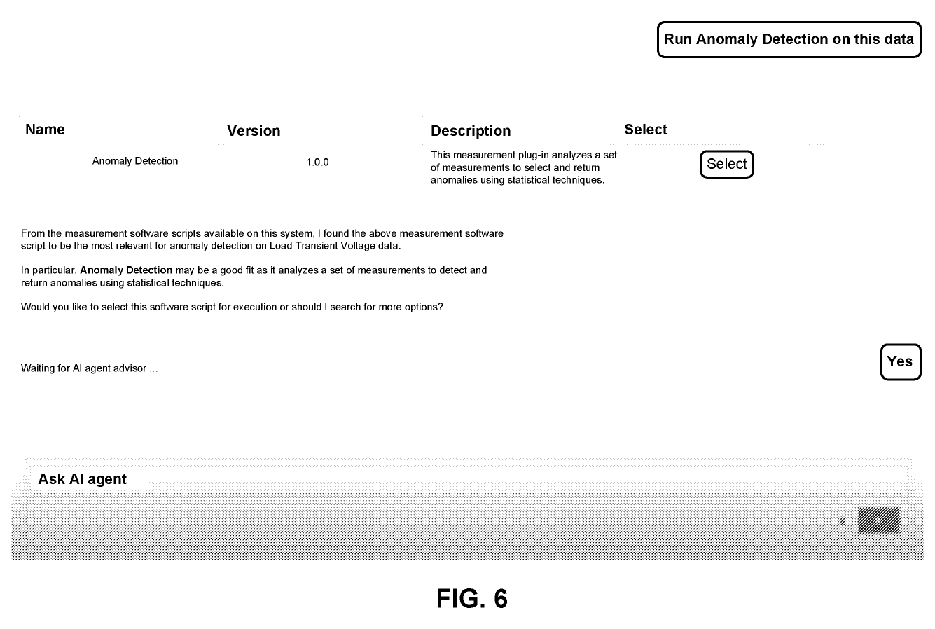

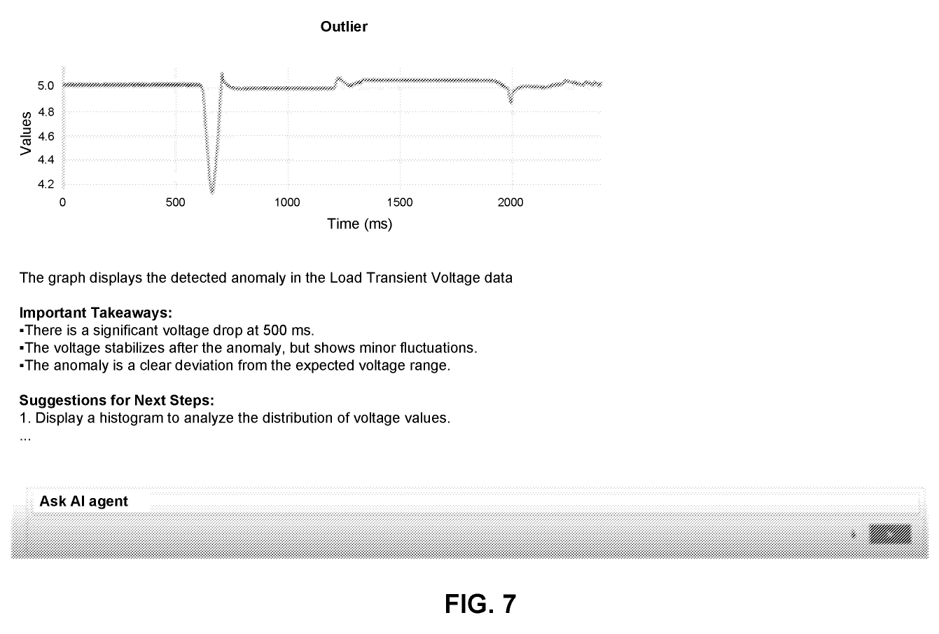

FIGS. 4-7 present examples of a user interface for an AI-ready repository of software programs that can be called without training. Notably, FIG. 4 presents a drawing illustrating a user interface in which a user asks an AI agent or advisor what software programs have been called recently in accordance with an embodiment of the present disclosure. Moreover, FIG. 5 presents a drawing illustrating a user interface in which a user tells the AI agent what datasets are of interest in accordance with an embodiment of the present disclosure. Furthermore, FIG. 6 presents a drawing illustrating a user interface in which a user tells the AI agent to look for anomalies in accordance with an embodiment of the present disclosure. The AI agent may identify an anomaly detection software program in the repository of software programs and may confirm with the user that this software program should be used. Additionally, FIG. 7 presents a drawing illustrating a user interface in which the AI agent successfully runs the anomaly detection software program and displays results in accordance with an embodiment of the present disclosure.

In some embodiments, the LLM may include a version or instance of: GPT (from OpenAI, Inc., of San Francisco, California), Claude (from Anthropic PBC, of San Francisco, California), Llama (from Meta AI, of New York City, New York), Gemini (from Google Corp., of Mountain View, California), Qwen (from Alibaba Cloud, of Hangzhou, China), DeepSeek (from Hangzhou DeepSeek Artificial Intelligence Basic Technology Research Co., Ltd, of Hangzhou, China), and/or another pretrained neural network that performs natural language processing.

The pretrained neural network may include one or more convolutional layers, one or more residual layers and one or more dense layers. Moreover, a given node in a given layer in the pretrained neural network may include an activation function that includes: a rectified linear unit (ReLU), a leaky ReLU, an exponential linear unit (ELU), a parametric ReLU, a tanh function, a sigmoid function, a gated linear unit (GLU), a Gaussian error linear unit (GeLU), and/or a swish function combined with a GLU (SwiGLU).

Note that the formats of packets or frames communicated during the repository techniques can include more or fewer bits, subfields or fields. Alternatively or additionally, the position of information in these packets or frames can be changed. Thus, the order of the subfields or fields can be changed.

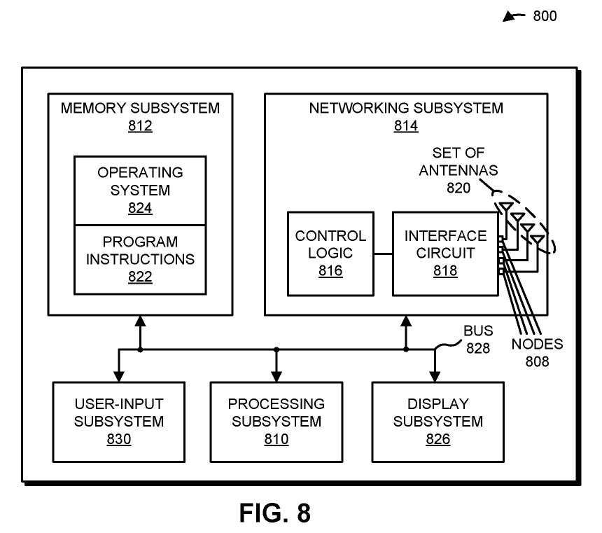

We now describe embodiments of an electronic device. FIG. 8 presents a block diagram of an electronic device 800 (which can be a cellular telephone, a computer in a computer system, another electronic device, etc.) in accordance with some embodiments. This electronic device includes processing subsystem 810, memory subsystem 812, and networking subsystem 814. Processing subsystem 810 includes one or more devices configured to perform computational operations. For example, processing subsystem 810 can include one or more microprocessors, application-specific integrated circuits (ASICs), microcontrollers, programmable-logic devices, one or more GPUs, and/or one or more DSPs.

Memory subsystem 812 includes one or more devices for storing data and/or instructions for processing subsystem 810 and networking subsystem 814. For example, memory subsystem 812 can include dynamic random access memory (DRAM), static random access memory (SRAM), a read-only memory (ROM), flash memory, and/or other types of memory. In some embodiments, instructions for processing subsystem 810 in memory subsystem 812 include: one or more program modules or sets of instructions (such as program instructions 822 or operating system 824), which can be executed by processing subsystem 810. For example, a ROM can store programs, utilities or processes to be executed in a non-volatile manner, and DRAM can provide volatile data storage, and can store instructions related to the operation of electronic device 800. Note that the one or more computer programs can constitute a computer-program mechanism, a computer-readable storage medium or software. Moreover, instructions in the various modules in memory subsystem 812 can be implemented in: a high-level procedural language, an object-oriented programming language, and/or in an assembly or machine language. Furthermore, the programming language can be compiled or interpreted, e.g., configurable or configured (which can be used interchangeably in this discussion), to be executed by processing subsystem 810. In some embodiments, the one or more computer programs are distributed over a network-coupled computer system so that the one or more computer programs are stored and executed in a distributed manner.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and a set of antennas 820 (or antenna elements) in an adaptive array that can be selectively turned on and/or off by control logic 816 to create a variety of optional antenna patterns or ‘beam patterns.’ (While FIG. 8 includes set of antennas 820, in some embodiments electronic device 800 includes one or more nodes, such as nodes 808 (which are sometimes referred to as ‘antenna nodes’), e.g., a pad or a connector, which can be coupled to set of antennas 820. Thus, electronic device 800 can or cannot include set of antennas 820.) For example, networking subsystem 814 can include a Bluetooth networking system, a Bluetooth Low Energy networking system, a cellular networking system (e.g., a 3G/4G/5G network such as UMTS, LTE, etc.), a universal serial bus (USB) networking system, a networking system based on the standards described in IEEE 802.11 (e.g., a Wi-Fi^{®} networking system), an Ethernet networking system, and/or another networking system.

In some embodiments, networking subsystem 814 includes one or more radios, such as a wake-up radio that is used to receive wake-up frames and wake-up beacons, and a main radio that is used to transmit and/or receive frames or packets during a normal operation mode. The wake-up radio and the main radio can be implemented separately (such as using discrete components or separate integrated circuits) or in a common integrated circuit.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 can use the mechanisms in networking subsystem 814 for performing simple wireless communication between the electronic devices, e.g., transmitting advertising or beacon frames and/or scanning for advertising frames transmitted by other electronic devices.

Within electronic device 800, processing subsystem 810, memory subsystem 812, and networking subsystem 814 are coupled together using bus 828 that facilitates data transfer between these components. Bus 828 can include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which can include a display driver and the display, such as a liquid-crystal display, a multi-touch touchscreen, etc. Display subsystem 826 can be controlled by processing subsystem 810 to display information to a user (e.g., information relating to incoming, outgoing, or an active communication session).

Electronic device 800 can also include a user-input subsystem 830 that allows a user of the electronic device 800 to interact with electronic device 800. For example, user-input subsystem 830 can take a variety of forms, such as: a button, keypad, dial, touch screen, audio input interface, visual/image capture input interface, input in the form of sensor data, etc.

Electronic device 800 can be (or can be included in) any electronic device with at least one network interface. For example, electronic device 800 can include: a cellular telephone or a smartphone, a tablet computer, a laptop computer, a notebook computer, a personal or desktop computer, a netbook computer, a media player device, an electronic book device, a MiFi® device, a smartwatch, a wearable computing device, a portable computing device, a consumer-electronic device, an access point, a router, a switch, communication equipment, test equipment, as well as any other type of electronic computing device having wireless communication capability that can include communication via one or more wireless communication protocols.

Although specific components are used to describe electronic device 800, in alternative embodiments, different components and/or subsystems can be present in electronic device 800. For example, electronic device 800 can include one or more additional processing subsystems, memory subsystems, networking subsystems, and/or display subsystems. Additionally, one or more of the subsystems cannot be present in electronic device 800. Moreover, in some embodiments, electronic device 800 can include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments program instructions 822 is included in operating system 824 and/or control logic 816 is included in interface circuit 818.

Moreover, the circuits and components in electronic device 800 can be implemented using any combination of analog and/or digital circuitry, including: bipolar, PMOS and/or NMOS gates or transistors. Furthermore, signals in these embodiments can include digital signals that have approximately discrete values and/or analog signals that have continuous values. Additionally, components and circuits can be single-ended or differential, and power supplies can be unipolar or bipolar.

An integrated circuit (which is sometimes referred to as a ‘communication circuit’) can implement some or all of the functionality of networking subsystem 814. This integrated circuit can include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals).

In some embodiments, an output of a process for designing the integrated circuit, or a portion of the integrated circuit, which includes one or more of the circuits described herein can be a computer-readable medium such as, for example, a magnetic tape or an optical or magnetic disk. The computer-readable medium can be encoded with data structures or other information describing circuitry that can be physically instantiated as the integrated circuit or the portion of the integrated circuit. Although various formats can be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematic diagrams of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used an Ethernet communication protocol as an illustrative example, in other embodiments a wide variety of communication protocols and, more generally, wireless communication techniques can be used. Thus, the repository techniques can be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments can be performed in hardware, in software or both. For example, at least some of the operations in the repository techniques can be implemented using program instructions 822, operating system 824 (such as a driver for interface circuit 818) or in firmware in interface circuit 818. Alternatively, or additionally, at least some of the operations in the repository techniques can be implemented in a physical layer, such as hardware in interface circuit 818. In some embodiments, the repository techniques are implemented, at least in part, in a MAC layer and/or in a physical layer in interface circuit 818.

While examples of numerical values are provided in the preceding discussion, in other embodiments different numerical values are used. Consequently, the numerical values provided are not intended to be limiting.

While the preceding embodiments illustrated the use of Ethernet during the repository techniques, in other embodiments of the repository techniques Wi-Fi, Bluetooth or Bluetooth Low Energy is used to communicate at least a portion of the information in the repository techniques. Furthermore, the information communicated in the repository techniques can be communicated in the same or a different band of frequencies that the band(s) of frequencies used by the main or primary radio. For example, the communication can use one or more bands of frequencies, including: 900 MHz, 2.4 GHz, 5 GHz, 6 GHz, 7 GHz, 60 GHz, a band of frequencies used by CBRS, and/or a band of frequencies used by LTE or another data communication protocol.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein can be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
an interface circuit configured to communicate with an electronic device;
a computation device configured to execute program instructions; and
memory that stores the program instructions, wherein, during operation, the computer system performs operations comprise:
receiving, from the electronic device, a query;
generating a search expression based at least in part on the query;
using the search expression, searching a repository of software
scripts for a set of candidate software programs and associated
descriptions;
providing information specifying the set of candidate software
scripts and the associated descriptions to a pretrained neural network;
receiving, from the pretrained neural network, second information
specifying a selected software program in the set of candidate software
scripts and an associated description; and
providing, to the electronic device, third information specifying
the selected software program and the associated description.

2. The computer system of claim 1, wherein the set of candidate software programs is identified during the searching based at least in part on rank scores.

3. The computer system of claim 2, wherein a given rank score in the rank scores is a weight summation of matches between keywords in the search expression and a given software program in the repository of software programs.

4. The computer system of claim 1, wherein the set of candidate software programs is identified during the searching based at least in part on distances between the query and the descriptions of software programs in the repository of software programs.

5. The computer system of claim 1, wherein the repository of software programs comprises a vector database.

6. The computer system of claim 1, wherein the pretrained neural network comprises a large language model (LLM).

7. The computer system of claim 1, wherein a given description in the descriptions of a given software program in the repository of software programs comprises: a data input/output (I/O) format, and a configuration.

8. The computer system of claim 7, wherein, for the given software program, the description indicates how to execute the software program.

9. The computer system of claim 7, wherein at least some of the software programs in the repository of software programs have different data I/O formats, different configurations, or both.

10. The computer system of claim 1, wherein the query comprises natural language.

11. The computer system of claim 1, wherein, when a second software program is added to the repository of software programs, the operations comprise:
generating an associated description for the second software program based at least in part on source code and one or more related files (such as a readme file) for the second software program; and
storing the generated associated description in the repository of software programs.

12. The computer system of claim 1, wherein the operations comprise receiving a context about what a user is doing or attempting to do, and the search expression is generated based at least in part on the context.

13. A non-transitory computer-readable storage medium for use with a computer system, the computer-readable storage medium storing program instructions, wherein, when executed by the computer system, the program instructions cause the computer system to perform operations comprising:
receiving, from an electronic device, a query;
generating a search expression based at least in part on the query;
using the search expression, searching a repository of software
scripts for a set of candidate software programs and associated descriptions;
providing information specifying the set of candidate software
scripts and the associated descriptions to a pretrained neural network;
receiving, from the pretrained neural network, second information
specifying a selected software program in the set of candidate software
scripts and an associated description; and
providing, to the electronic device, third information specifying
the selected software program and the associated description.

14. The non-transitory computer-readable storage medium of claim 13, wherein the set of candidate software programs is identified during the searching based at least in part on rank scores; and
wherein a given rank score in the rank scores is a weight summation of matches between keywords in the search expression and a given software program in the repository of software programs.

15. The non-transitory computer-readable storage medium of claim 13, wherein the set of candidate software programs is identified during the searching based at least in part on distances between the query and the descriptions of software programs in the repository of software programs.

16. The non-transitory computer-readable storage medium of claim 13, wherein the pretrained neural network comprises a large language model (LLM).

17. A method for selecting a software program, comprising:
by a computer system:
receiving, from an electronic device, a query;
generating a search expression based at least in part on the query;
using the search expression, searching a repository of software
scripts for a set of candidate software programs and associated descriptions;
providing information specifying the set of candidate software
scripts and the associated descriptions to a pretrained neural network;
receiving, from the pretrained neural network, second information
specifying a selected software program in the set of candidate software
scripts and an associated description; and
providing, to the electronic device, third information specifying
the selected software program and the associated description.

18. The method of claim 17, wherein the set of candidate software programs is identified during the searching based at least in part on rank scores; and
wherein a given rank score in the rank scores is a weight summation of matches between keywords in the search expression and a given software program in the repository of software programs.

19. The method of claim 17, wherein the set of candidate software programs is identified during the searching based at least in part on distances between the query and the descriptions of software programs in the repository of software programs.

20. The method of claim 17, wherein the pretrained neural network comprises a large language model (LLM).
